(19) United States
(12) Patent Application Publication
(10) Pub. No.: US 2004/0254016 A1
(43) Pub. Date: Dec. 16, 2004

(54) Game apparatus and method for controlling game machine

(75) Inventor: Katsuya Shimazaki, Tokyo (JP)

Correspondence Address: SUGHRUE MION, PLLC, 2100 PENNSYLVANIA AVENUE, N.W., SUITE 800, WASHINGTON, DC, 20037, US

(73) Assignees: KONAMI CORPORATION; KONAMI COMPUTER ENTERTAINMENT TOKYO, INC.

(21) Appl. No.: 10/840,622

(22) Filed: May 7, 2004

(30) Foreign Application Priority Data
May 13, 2003 (JP) 2003-135110

(51) Int. Cl. A63F 13/00

(52) U.S. Cl. 463/33

(57) ABSTRACT

To provide a game apparatus that enable notifying a player of a predetermined position by displaying a marker object designating a predetermined position in accordance with the position of an operation target object in a game space, a game apparatus that displays an image related to a three-dimensional game space (50) where a player game character (52) as an operation target object is arranged, includes position control means for controlling the position of the player game character (52) in the three-dimensional game space (50) on the basis of an operation signal, and marker object arrangement means for arranging in the three-dimensional game space (50) a marker object (64) designating a predetermined position (path to another area) in the three-dimensional game space (50) in accordance with the position of the player game character (52).

### BACKGROUND OF THE INVENTION

This invention relates to a game apparatus and a method for controlling a game machine, and particularly to a technique of suitably displaying a marker object designating a position in a game space.

A game has been known that enables arrangement of an operation target object in game space constructed on a memory and control of its position based on an operation signal inputted by a controller. In a game of this type, often, a game space is sectioned by a wall object or the like and the game is caused to proceed in the sectioned area. An object such as a door is arranged in the area so that the operation target object can be moved from one area to another area. As the operation target object approaches the position of the door or the like, the operation target object is moved to another area.

However, in the conventional game, the operation target object might be accidentally caused to approach the position where the door or the like is installed, and the operation target object might be moved to another area unexpectedly. Therefore, the enjoyment of the game is reduced in some cases.

### SUMMARY OF THE INVENTION

In view of the foregoing problem, it is an object of this invention to provide a game apparatus and a method for controlling a game machine that enable notifying a player of a position by displaying a marker object designating the position in accordance with the position of the operation target object in the game space.

In order to solve the foregoing problem, a game apparatus according to this invention is a game apparatus that displays an image related to a game space where an operation target object is arranged, characterized in that the apparatus includes operation signal input means for inputting operation signals, position control means for controlling the position of the operation target object in the game space based on the operation signals, and marker object arrangement means for arranging, in the game space, a marker object designating a predetermined position in the game space in accordance with the position of the operation target object.

Moreover, a method for controlling a game machine according to this invention is characterized in that the method includes a step of displaying an image related to a game space where an operation target object is arranged, a step of controlling the position of the operation target object in the game space based on operation signals, and a step of arranging, in the game space, a marker object designating a predetermined position in the game space in accordance with the position of the operation target object.

Furthermore, a computer-readable information storage medium according to this invention has a program stored therein, the program being adapted for causing a computer to function as a game apparatus that displays an image related to a game space where an operation target object is arranged, the program including commands to cause the computer to function as position control means for controlling the position of the operation target object in the game space based on operation signals, and marker object arrangement means for arranging, in the game space, a marker object designating a predetermined position in the game space in accordance with the position of the operation target object.

According to this invention, a marker object designating a predetermined position in the game space can be displayed in accordance with the position of the operation target object, and a player can be notified of the predetermined position in a straightforward manner.

In one embodiment of this invention, the marker object arrangement means arranges the marker object in the game space in accordance with the distance between the operation target object and the predetermined position. By doing so, it is possible to realize display or non-display of the marker object in accordance with the distance. In this case, the marker object may be arranged, for example, in accordance with comparison between the distance and a predetermined reference distance, more specifically, when the distance is shorter than the predetermined reference distance.

In one embodiment of this invention, the marker object arrangement means arranges the marker object in the game space in accordance with the position of the operation target object and an area set in association with the predetermined position. By doing so, it is possible to arrange the marker object when the object enters the area or the like.

In one embodiment of this invention, display mode decision means for deciding a display mode of the marker object based on the distance between the operation target object and the predetermined position is included. By doing so, it is possible to estimate the distance between the operation target object and the predetermined position, referring to the display mode of the marker object.

### BRIEF DESCRIPTION OF THE DRAWINGS

FIG. 1 is a view showing the hardware structure of a game apparatus according to an embodiment of this invention.

FIG. 2 is a view showing an example of a three-dimensional game space (before appearance of marker objects).

FIG. 3 is a view showing an example of the three-dimensional game space (after appearance of marker objects).

FIG. 4 is a flowchart showing a game screen generation routine.

FIG. 5 is a view showing a three-dimensional game space for explaining another display condition of marker objects.

### DESCRIPTION OF THE PREFERRED EMBODIMENT

Hereinafter, a preferred embodiment of this invention will be described in detail on the basis of the drawings.

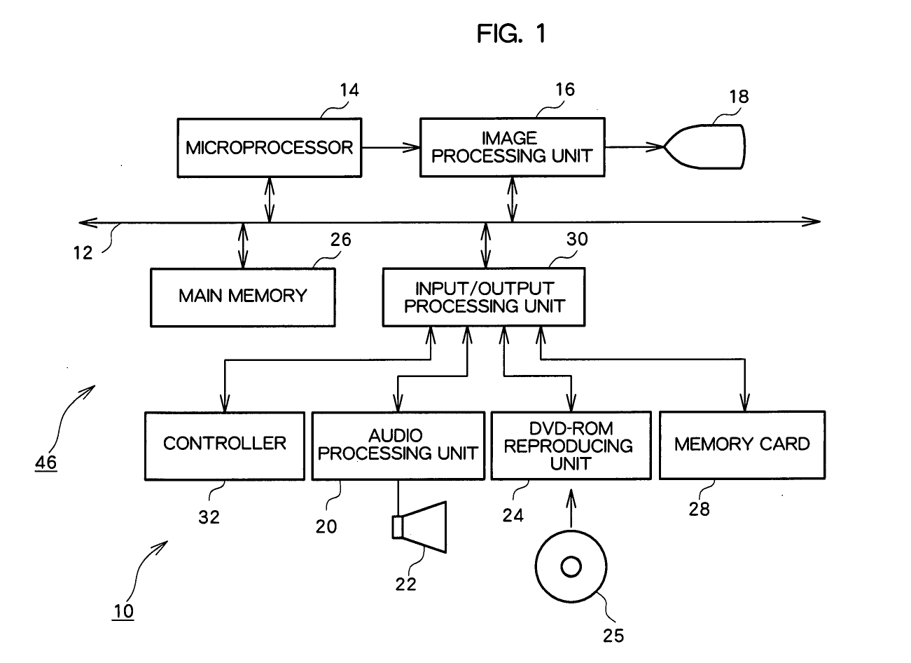

FIG. 1 is a view showing the hardware structure of a game apparatus according to one embodiment of this invention. A game apparatus 10 shown in FIG. 1 is constructed by connecting a monitor 18 and a speaker 22 to a home game machine 46 and also loading a DVD-ROM 25 thereto, which is an information storage medium. Although in this case, the DVD-ROM 25 is used for supplying a game program and game data to the home game machine 46, any other information storage medium such as a CD-ROM or ROM card can be used. The game program and game data may also be supplied to the home game machine 46 from a remote location via a communication network.

The home game machine 46 is a known computer game system in which a microprocessor 14, an image processing unit 16, a main memory 26 and an input/output processing unit 30 are connected with each other by a bus 12 in such a manner that mutual data communication is possible, and in which a controller 32, an audio processing unit 20 and a DVD-ROM reproducing unit 24 are connected to the input/output unit 30. The constituent elements of the home game machine 46 excluding the controller 32 are housed in a casing. As the monitor 18, for example, a home television receiver is used, and for example, its built-in speaker is used as the speaker 22.

The microprocessor 14 controls each part of the home game machine 46 on the basis of an operating system stored in a ROM, not shown, and the game program read out from the DVD-ROM 25. The bus 12 is for communication of an address or data between the parts of the home game machine 46. The main memory 26 includes a RAM, in which the game program or game data read out from the DVD-ROM 25 is written when necessary. In the main memory 26, also work area for various data processing by the microprocessor 14 is secured. The image processing unit 16 includes a VRAM (video RAM). The image processing unit 16 receives image data sent from the microprocessor 14 and plots a game screen on the VRAM. It also converts the content of the image data to a video signal and outputs the video signal to the monitor 18 at predetermined timing.

The input/output processing unit 30 is an interface for relaying data communication between each of the controller 32, the audio processing unit 20, the DVD-ROM reproducing unit 24 and a memory card 42, and the microprocessor 14. The controller 32 is input means for a player to perform a game operation. The input/output processing unit 30 scans the operation states of various buttons of the controller 32 in a predetermined cycle (for example, every 1/60 seconds), and sends an operation signal representing the result of the scanning to the microprocessor 14 via the bus 12. The microprocessor 14 judges the content of the player's operation of the controller 32 on the basis of the operation signal. The audio processing unit 20 includes a sound buffer. It reproduces data such as music and game sound effects read out from the DVD-ROM 25 and stored in the sound buffer, and outputs the data from the speaker 22. The DVD-ROM reproducing unit 24 reads out the gate program and game data recorded in the DVD-ROM 25 in accordance with an instruction from the microprocessor 14. The memory card 42 is non-volatile removable memory means and is used for storing various game data.

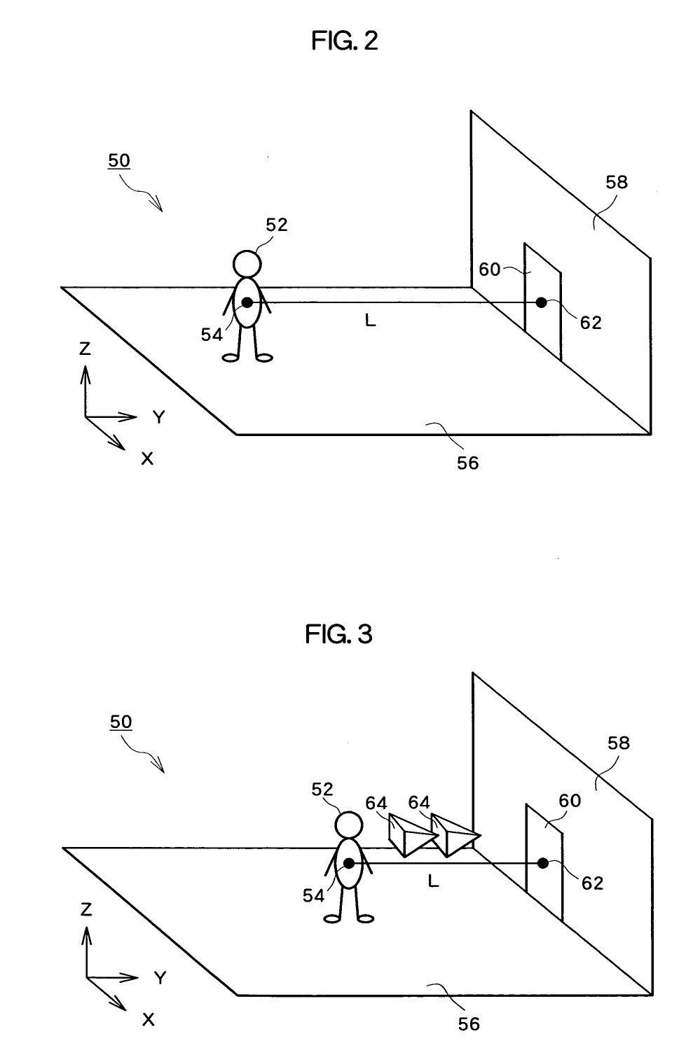

In this game apparatus 10, a virtual game space, that is, three-dimensional game space (virtual three-dimensional space), is constructed in the main memory 26. FIG. 2 is a view schematically showing a part of this three-dimensional space. In a three-dimensional game space 50 shown in FIG. 2, a player game character 52, which is an operation target object, is arranged on a flat plate-like floor object 56. The operation target object is operated by the player using the controller 32. As the player inputs an operation signal using a cross key or the like provided on the controller 32, the position of the player game character 52 in the three-dimensional game space 50 can be changed in accordance with the operation signal. A wall object 58 is provided in an upright manner at an edge of the floor object 56. The wall object 58 is provided for limiting the range of movement of the player game character 52 in the three-dimensional game space 50. An opening is provided at a part of the wall object 58 and a door object 60 is arranged at that position. When the player game character 52 approaches the door object 60, it is directed that the door object 60 makes an opening motion and the player game character 52 moves to another area in the three-dimensional game space 50. A viewpoint is arranged in the three-dimensional game space 50, and the view of the three-dimensional game space 50 viewed from the viewpoint is displayed on the monitor 18. To carry out information processing related to the three-dimensional game space 50 shown in FIG. 2, a three-dimensional coordinate is set in this space in which directions parallel to the floor surface of the floor object 56 are regarded as an X-direction and a Y-direction and a direction perpendicular to the floor surface is regarded as a Z-direction.

One feature of this game apparatus 10 is that when the player game character 52 approaches the position of the door object 60 (position of the opening in the wall object 58) in accordance with the operation by the controller 32, a marker object 64 appears in the three-dimensional game space 50 and is displayed on the monitor 18, as shown in FIG. 3. Therefore, in this game apparatus 10, the distance L between a representative point 54 set in association with the player game character 52 and a position 62 of the door object 60 is calculated every predetermined time period, and if the distance L is smaller than a predetermined distance Lp, plural marker objects 64 are caused to appear before the door object 60 in the three-dimensional game space 50. These marker objects 64 have a triangular pyramidal shape and each of the marker objects is set to designate (be oriented to) the door object 60. The position of appearance of the marker objects 64 in the three-dimensional game space 50 may be stored in advance in the DVD-ROM 25 in association with the door object 60 or may be calculated when necessary on the basis of the position 62 associated with the door object 60 and the direction (posture) of the door object 60. While the marker objects 64 are displayed on the monitor 18, it is desired to clearly notify the player of the existence of the marker objects 64, for example, by rotating or flashing the marker objects 64 in a predetermined cycle. A condition of displaying the marker objects 64 may be set in advance for every path such as the door object 60. For example, for an object representing a hidden door, the display of the marker objects 64 may be limited until the player game character passes once through a path related to this object, or the marker objects 64 may be displayed only when a past play by the player meets a predetermined condition (whether the player held a key item or not, or whether the player cleared a predetermined game event or not).

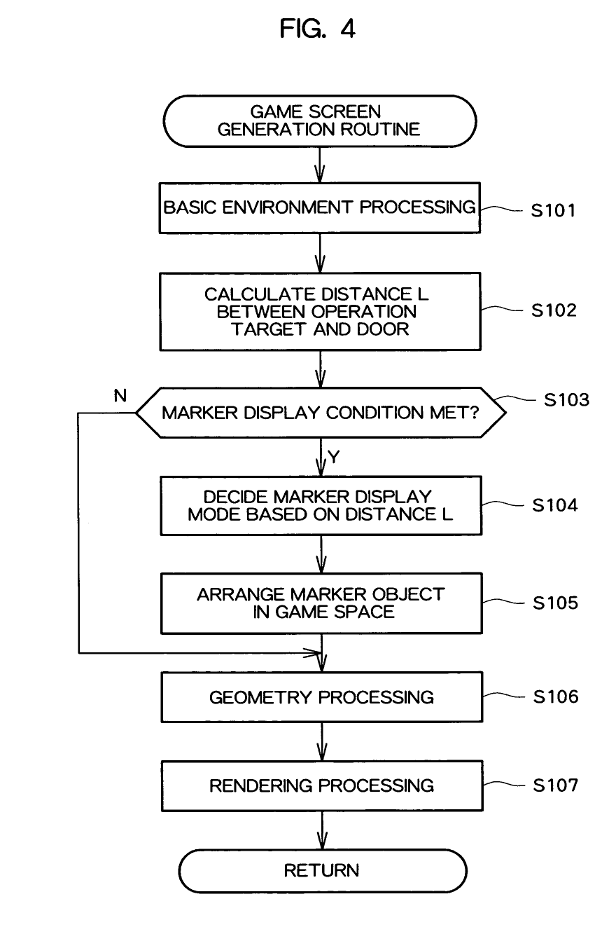

FIG. 4 is a flowchart showing a game screen generation routine executed every predetermined time (for example, every 1/60 seconds) in this game apparatus 10. As shown in FIG. 4, in this game apparatus 10, basic environment processing is executed first (S101). The basic environment processing is conventionally known processing. In this case, the positions (locations and postures) of all the static objects and dynamic objects in the three-dimensional game space are calculated. The static objects are objects that do not change their positions with the lapse of time such as the floor object 56 and the wall object 58. On the other hand, the dynamic objects are objects that change their positions and postures such as the player game character 52 and the door object 60 (at the time of opening and closing).

In the basic environment processing, the coordinate of the view point, viewing direction and view angle are also calculated. For example, the view point coordinate may be set up in the air behind the player game character 52. The viewing direction may be set toward the representative point 54 of the player game character 52.

Next, in the game apparatus 10, the distance L between the representative point 54 of the player game character 52 and the position 62 associated with the door object 60 is calculated (S102). The position 62 is stored in advance, for example, in the DVD-ROM 25, as the content of the three-dimensional game space 50. The representative point 54 of the player game character 52 moves in the three-dimensional game space 50 in accordance with an operation by the controller 32 and is calculated in the basic environment processing (S101). The representative point 54 is set in association with the player game character 52 and is set, for example, at the center of the player game character 52.

Next, it is judged whether the display conditions of the marker objects 64 are fulfilled or not (S103). That is, in the game apparatus 10, it is judged whether or not conditions such as (1) that the distance L is smaller than the predetermined distance Lp and (2) that it is not immediately after the player game character 52 passed the door object 60 are met. Whether it is immediately after the player game character 52 passed the door object 60 can be judged, for example, by using a condition such that the distance L has never been equal to or larger than the predetermined distance Lp since the player game character 52 passed the door object 60, or that no operation has been made to move the player game character 52 toward the door object 60 since the player game character 52 passed the door object 60.

If the display conditions are fulfilled, a display mode of the marker objects 64 is decided based on the distance L calculated at step S102 (S104). For example, a display mode is set such that the flashing speed of the marker objects 64 increases as the distance L decreases (the flashing speed is decided based on the distance L). Alternatively, a display mode is decided such that the color of the marker objects 64 becomes darker as the distance L decreases (the alpha value of the texture used for the marker objects 64 is decided based on the distance L). According to the decided display mode, the marker objects 64 are arranged before the door object 60 in the three-dimensional game space 50 (S105). On the other hand, if the display conditions are not fulfilled, the processing of S104 and S105 is skipped.

By the above-described processing of steps S102 to S105, the marker objects 64 are arranged before the door object in the display mode based on the distance L in accordance with the distance L between the representative point 54 of the player game character 52 and the position 62 associated with the door object 60.

After that, in this game apparatus 10, geometry processing is executed (S106). In the geometry processing, coordinate transformation is carried out from S101 and a world coordinate system (XW, YW, ZW) to a viewing coordinate system, that is, a coordinate system having the view point coordinate as the origin, the viewing direction as Z-direction, the horizontal direction as X-direction and the vertical direction as Y-direction. Moreover, color information of vertexes of polygons constituting each object is calculated based on light source information (color and position of a light source). Furthermore, clipping processing is performed.

After that, in this game apparatus 10, rendering processing is executed (S107). That is, the microprocessor 14 sends the vertex coordinate, vertex color information, texture coordinate and the like of each polygon within the view to the image processing unit 16. Then, the image processing unit 16 forms an image representing a game screen on the VRAM based on such information. This image is formed by transforming each object described in the viewing coordinate system to a screen coordinate system. In this manner, the image formed on the VRAM is outputted to the monitor 18 at predetermined timing.

As described above, according to this game apparatus 10, the marker objects 64 can be displayed before the door object 60 in the display mode based on the distance L, in response to the distance L between the representative point 54 of the player game character 52 and the position 62 associated with the door object 60, and the player can be notified of the existence of the door object 60 when necessary. That is, in the game apparatus that displays an image related to the three-dimensional game space 50 where the player game character 52 is arranged as an operation target object, in which the position of the player game character 52 in the three-dimensional game space 50 is controlled based on operation signals and arranging in the three-dimensional game space 50 the marker objects 64 designating a predetermined position (path to another area) in the three-dimensional game space 50 in response to the position of the player game character 52, it is possible to suitably notify the player of the existence of the predetermined position.

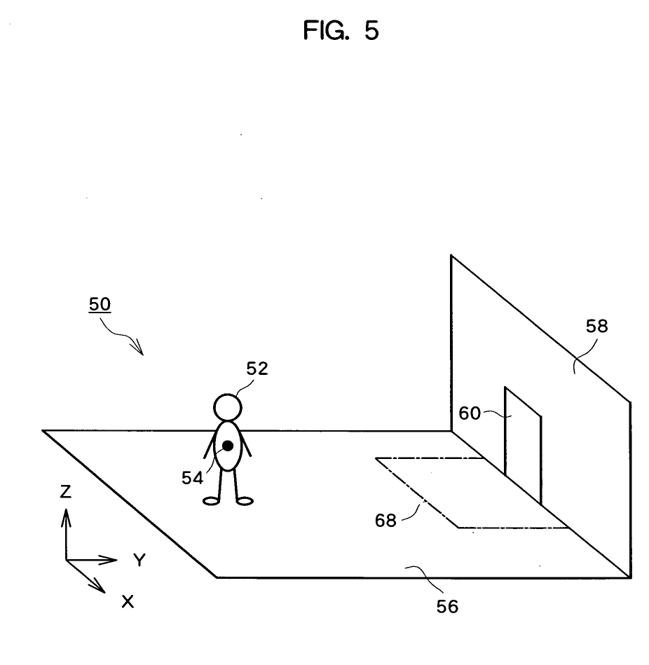

This invention is not limited to the above-described embodiment. For example, the display conditions of the marker objects 64 are not limited to the above-described display conditions. A marker appearance area 68 may be set in association with the door object 60, as shown in FIG. 5, and when the player game character 52 enters the area, the marker objects 64 may be displayed before the door object 60. For example, the marker appearance area 68 is set as a plane area on the floor surface of the floor object 56, and if the values of the X and Y components of the representative point 54 fall within this area, it may be judged that the player game character 52 has entered the marker appearance area 68.

What is claimed is:

1. A game apparatus that displays an image related to a game space where an operation target object is arranged, characterized in that the apparatus includes
operation signal input means for inputting operation signals,
position control means for controlling the position of the operation target object in the game space based on the operation signals, and
marker object arrangement means for arranging, in the game space, a marker object designating a predetermined position in the game space in accordance with the position of the operation target object.

2. The game apparatus as claimed in claim 1, characterized in that the marker object arrangement means arranges the marker object in the game space in accordance with the distance between the operation target object and the predetermined position.

3. The game apparatus as claimed in claim 1, characterized in that the marker object arrangement means arranges the marker object in the game space in accordance with the position of the operation target object and an area set in association with the predetermined position.

4. The game apparatus as claimed in one of claims 1 to 3, characterized in that the apparatus further includes display mode decision means for deciding a display mode of the marker object based on the distance between the operation target object and the predetermined position.

5. A method for controlling a game machine characterized in that the method includes
a step of displaying an image related to a game space where an operation target object is arranged,
a step of controlling the position of the operation target object in the game space based on operation signals, and
a step of arranging, in the game space, a marker object designating a predetermined position in the game space in accordance with the position of the operation target object.

6. A program for causing a computer to function as a game apparatus that displays an image related to a game space where an operation target object is arranged, the program including commands to cause the computer to function as
position control means for controlling the position of the operation target object in the game space based on operation signals, and
marker object arrangement means for arranging, in the game space, a marker object designating a predetermined position in the game space in accordance with the position of the operation target object.
